(19) United States
(12) Patent Application Publication
(10) Pub. No.: US 2021/0262351 A1
(43) Pub. Date: Aug. 26, 2021

(54) ROTARY MACHINE

(71) Applicant: MITSUBISHI HEAVY INDUSTRIES, LTD., Tokyo (JP)

(72) Inventor: Toshihiko AZUMA, Tokyo (JP)

(21) Appl. No.: 17/167,712

(22) Filed: Feb. 4, 2021

(30) Foreign Application Priority Data
Feb. 25, 2020 (JP) 2020-029318
Dec. 4, 2020 (JP) 2020-202184

(51) Int. Cl. F01D 5/16; F01D 5/14

(52) U.S. Cl. CPC F01D 5/16; F01D 5/147; F05D 2260/96; F05D 2240/30; F05D 2220/32

(57) ABSTRACT

A rotary machine includes a rotor shaft that is rotatable about an axis, a plurality of blades extending radially outward from the rotor shaft and arranged in a circumferential direction, and a casing that covers the rotor shaft and the plurality of blades from an outer peripheral side. Each of the plurality of blades includes a blade body including a leading edge facing forward in a rotational direction of the rotor shaft, a trailing edge facing backward, and a tip facing radially outward, and a weight of the blade body is different between at least two of the plurality of blades.

### CROSS-REFERENCE TO RELATED APPLICATIONS

This application claims the benefit of priority to Japanese Patent Application Number 2020-029318 filed on Feb. 25, 2020, and Japanese Patent Application Number 2020-202184 filed on Dec. 4, 2020. The entire contents of the above-identified application are hereby incorporated by reference.

### TECHNICAL FIELD

The present disclosure relates to a rotary machine.

### RELATED ART

A gas turbine includes a compressor, a combustor, and a turbine. The compressor compresses external air to generate high-pressure air. The combustor mixes fuel with high-pressure air and combusts the mixture to generate high-temperature and high-pressure combustion gas. The turbine is rotationally driven by the combustion gas. The rotational force of the turbine is taken out from the shaft end and used for driving a power generator or the like.

The compressor includes a rotor that rotates around an axis, a plurality of rotor blade rows (blades) provided on an outer peripheral surface of the rotor, a casing that covers the rotor and the rotor blade rows from an outer peripheral side, and a plurality of stator vane rows provided on an inner peripheral surface of the casing.

In recent years, the size of blades has been increased in order to improve the performance of compressors. On the other hand, there is also a demand to suppress an increase in weight of the blade. As a technique for achieving both an increase in size and a reduction in weight, for example, a blade (fan blade) described in JP 2017-172582 A is known. The fan blade has an airfoil body formed of carbon fiber reinforced resin and a metal cladding attached to a portion of the airfoil body. When the airfoil body is formed of a carbon fiber reinforced resin, it is considered that the weight of the airfoil body can be greatly reduced as compared with aluminum or the like which has been conventionally used.

### SUMMARY

However, it is known that when the weight of the blade is reduced as described above, a vibration phenomenon called flutter is likely to occur. In particular, in a case where the plurality of blades have the same natural frequency, there is a concern that the flutter may develop in a self-excited manner. As a result, stable operation of the gas turbine (rotary machine) is inhibited.

The present disclosure has been made to solve the above problem, and an object of the present disclosure is to provide a rotary machine capable of operating more stably.

In order to solve the above problems, the rotary machine according to the present disclosure includes a rotor shaft that is rotatable about an axis, a plurality of blades extending radially outward from the rotor shaft and arranged in a circumferential direction, a casing that covers the rotor shaft and the plurality of blades from an outer peripheral side. Each of the plurality of blades includes a blade body including a leading edge facing forward in a rotational direction of the rotor shaft, a trailing edge facing backward, and a tip facing radially outward, and a weight of the blade body is different between at least two of the plurality of blades.

According to the present disclosure, it is possible to provide a rotary machine capable of operating more stably.

### BRIEF DESCRIPTION OF DRAWINGS

The disclosure will be described with reference to the accompanying drawings, wherein like numbers reference like elements.

FIG. 1 is a schematic diagram illustrating a configuration of a rotary machine (gas turbine) according to a first embodiment of the present disclosure.

FIG. 2 is a plan view of a blade according to the first embodiment of the present disclosure.

FIG. 3 is a plan view of a blade according to a second embodiment of the present disclosure.

FIG. 4 is a plan view of another blade according to the second embodiment of the present disclosure.

FIG. 5 is a plan view illustrating a modified example of the blade according to the second embodiment of the present disclosure.

FIG. 6 is a plan view illustrating another modified example of the blade according to the second embodiment of the present disclosure.

FIG. 7 is a plan view of a blade according to a third embodiment of the present disclosure.

FIG. 8 is a plan view illustrating a modified example of the blade according to the third embodiment of the present disclosure.

### DESCRIPTION OF EMBODIMENTS

### First Embodiment

### Configuration of Gas Turbine

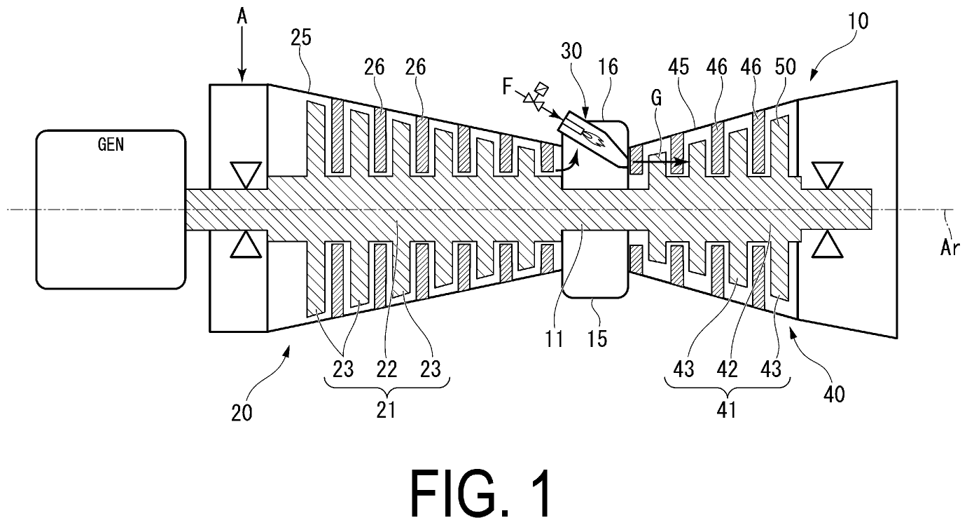

Hereinafter, a gas turbine 10 as a rotary machine according to a first embodiment of the present disclosure will be described with reference to FIGS. 1 to 3. As illustrated in FIG. 1, the gas turbine 10 includes a compressor 20 that compresses air A, a combustor 30 that combusts fuel F in the compressed air A to generate combustion gas G, and a turbine 40 that is driven by the combustion gas G. The compressor 20, the combustor 30, and the turbine 40 are arranged in the gas flow direction. In the following description, a side on which the turbine 40 is located when viewed from the compressor 20 is referred to as a downstream side, and a side on which the compressor 20 is located when viewed from the turbine 40 is referred to as an upstream side.

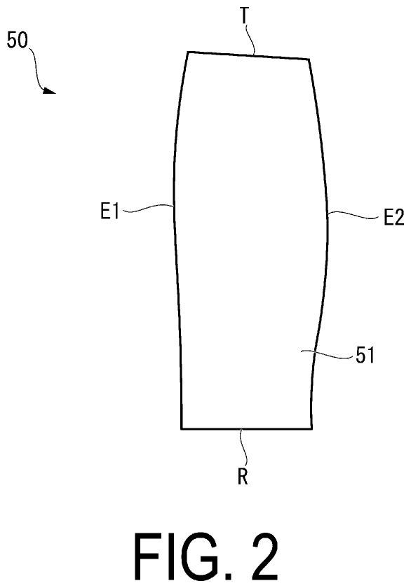

The compressor 20 includes a compressor rotor 21, a compressor casing 25 (casing), and a compressor stator vane row 26. The compressor rotor 21 includes a rotor shaft 22 and a compressor rotor blade row 23. The rotor shaft 22 has a columnar shape extending along an axis Ar and is rotatable about the axis Ar. A plurality of compressor rotor blade rows 23 are provided on the rotor shaft 22 at intervals in the direction of the axis Ar. Each of the compressor rotor blade rows 23 is composed of a plurality of compressor rotor blades 50 (blade: see FIG. 2), which extend radially outward from the outer peripheral surface of the rotor shaft 22 and are arranged at intervals in the circumferential direction.

The compressor casing 25 has a cylindrical shape that covers the rotor shaft 22 and the compressor rotor blade rows 23 from the outer peripheral side. A plurality of compressor stator vane rows 26 are provided on an inner peripheral surface of the compressor casing 25. A plurality of compressor stator vane rows 26 are provided at intervals in the direction of the axis Ar. The compressor stator vane rows 26 are arranged alternately with the compressor rotor blade rows 23 in the direction of the axis Ar. Each of the compressor stator vane rows 26 is composed of a plurality of compressor stator vanes, which extend radially inward from the inner peripheral surface of the compressor casing 25 and are arranged at intervals in the circumferential direction.

The combustor 30 is provided in the intermediate casing 16 connected to a downstream side of the compressor casing 25. The combustor 30 generates high-temperature and high-pressure combustion gas G by mixing fuel F with high-pressure air A generated by the compressor 20 and combusting the mixture. The combustion gas G is sent to the turbine 40 connected to a downstream side of the intermediate casing 16.

The turbine 40 includes a turbine rotor 41, a turbine casing 45, and a turbine stator vane row 46. The turbine rotor 41 includes a rotor shaft 42 and a turbine rotor blade row 43. The rotor shaft 42 has a columnar shape extending along the axis Ar and is rotatable about the axis Ar. A plurality of turbine rotor blade rows 43 are provided on the rotor shaft 42 at intervals in the direction of the axis Ar. Each of the turbine rotor blade rows 43 is composed of a plurality of turbine rotor blades, which extend radially outward from the outer peripheral surface of the rotor shaft 42 and are arranged at intervals in the circumferential direction.

The turbine casing 45 has a cylindrical shape that covers the rotor shaft 42 and the turbine rotor blade rows 43 from the outer peripheral side. A plurality of turbine stator vane rows 46 are provided on an inner peripheral surface of the turbine casing 45. A plurality of turbine stator vane rows 46 are provided at intervals in the direction of the axis Ar. The turbine stator vane rows 46 are arranged alternately with the turbine rotor blade rows 43 in the direction of the axis Ar. Each of the turbine stator vane rows 46 is composed of a plurality of turbine stator vanes, which extend radially inward from the inner peripheral surface of the turbine casing 45 and are arranged at intervals in the circumferential direction.

The compressor rotor 21 and the turbine rotor 41 are coaxially connected on the axis Ar to form the gas turbine rotor 11. The compressor casing 25, the intermediate casing 16, and the turbine casing 45 are integrally connected in the direction of the axis Ar to form the gas turbine casing 15.

The compressor 20 sucks air A and compresses it. The compressed air A flows into the combustor 30 through the intermediate casing 16. The combustor 30 is supplied with fuel F from the outside. The combustor 30 combusts fuel F in the compressed air to generate combustion gas G. The combustion gas G flows into the turbine casing 45 to rotate the turbine rotor 41. The rotation of the turbine rotor 41 causes the power generator GEN to generate electric power.

### Configuration of Blade

Next, the configuration of a compressor rotor blade 50 will be described with reference to FIG. 2. The configuration of the compressor rotor blade 50 described below is more preferably applied to the first (most upstream) compressor rotor blade row 23 among the plurality of compressor rotor blade rows 23 described above. When a turbofan engine is used as the rotary machine, the configuration of the compressor rotor blade 50 can be applied as the fan blade of the bypass fan located on the most upstream side.

As illustrated in FIG. 2, the compressor rotor blade 50 includes a blade body 51. The blade body 51 includes a blade root R that is an end portion radially inward, a tip T that is an end portion radially outward, and a leading edge E1 and a trailing edge E2 that connect the blade root R and the tip T in the radial direction.

The blade root R is fixed to the outer peripheral surface of the rotor shaft 22. Although not illustrated in detail, the blade root R is formed with a serration or a dovetail that engages with a blade groove provided in the rotor shaft 22. The leading edge E1 is an end edge facing forward in the rotational direction of the rotor shaft 22. The trailing edge E2 is an end edge facing backward in the rotational direction. When viewed in the radial direction, the blade body 51 has an airfoil cross-sectional shape. To be more specific, the cross-sectional shape of the blade body 51 is a spindle shape extending from the leading edge E1 side toward the trailing edge E2 side. In the present embodiment, the tip T has a linear shape extending from the leading edge E1 to the trailing edge E2. Note that the shapes of the leading edge E1, the trailing edge E2, and the tip T can be appropriately changed according to design and specifications. The blade body 51 is integrally formed of a material selected from, for example, carbon fiber reinforced resin, aluminum, and a Ni-based alloy, or the like.

The weight of the blade body 51 is different between at least two compressor rotor blades 50 among the plurality of compressor rotor blades 50. Specifically, the blade bodies 51 are made of different materials each other. In other words, the shapes and dimensions are the same as each other except for the material of the blade body 51.

### Operational Effects

Here, in a case where the plurality of compressor rotor blades 50 have the same weight (i.e., the same natural frequency), there is a concern that these blades resonate with each other and flutter develops in a self-excited manner. As a result, stable operation of the gas turbine (rotary machine) is inhibited.

However, according to the above configuration, the weight of the blade body 51 differs between at least two compressor rotor blades 50 and 50′ among the plurality of compressor rotor blades 50. That is, since the two compressor rotor blades 50 and 50′ have different weights as a whole, their natural frequencies are different. Therefore, for example, even when flutter occurs in one of the compressor rotor blades 50, it is possible to reduce the possibility that the other compressor rotor blade 50′ resonates due to the flutter. This can avoid the development of flutter. As a result, the gas turbine 10 can be operated more stably.

The first embodiment of the present disclosure has been described above. Various changes and modifications can be made to the above-described configuration without departing from the gist of the present disclosure.

### Second Embodiment

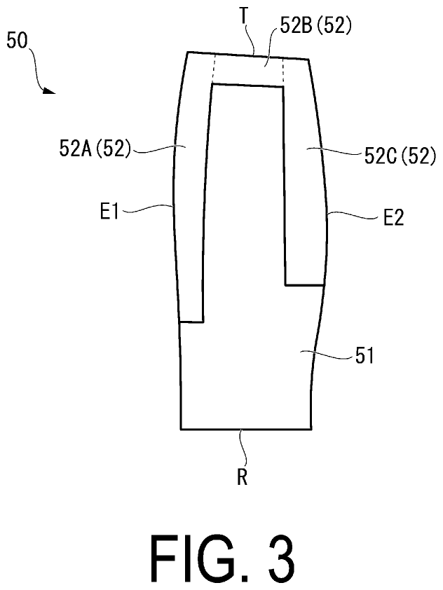

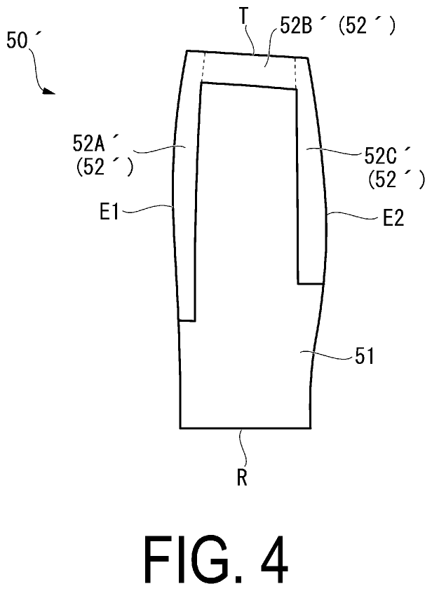

Next, a second embodiment of the present disclosure will be described with reference to FIGS. 3 and 4. The same components as those of the first embodiment are denoted by the same reference signs, and detailed description thereof will be omitted. As illustrated in FIG. 3, in the present embodiment, at least one of the leading edge E1, the trailing edge E2, and the tip T is covered by a cover 52. In the present embodiment, all of the leading edge E1, the trailing edge E2, and the tip T are covered by the cover 52. The cover 52 is formed of a material having a density different from that of the material constituting the blade body 51. The cover 52 is, for example, a foil-shaped metal. More specifically, titanium or tungsten is preferably used as the cover 52. A portion covered by the cover 52 forms a surface continuous with a portion not covered by the cover 52. In other words, the cover 52 covers the blade body 51 so as not to protrude from the surface of the blade body 51 or form a step.

The leading edge E1 is provided with a leading edge cover 52A. The leading edge cover 52A covers a region from a position radially outward of the blade root R to the tip T in the radial direction. Further, the leading edge cover 52A covers only a region biased toward the leading edge E1 side among regions from the leading edge E1 to the trailing edge E2 side.

The trailing edge E2 is provided with a trailing edge cover 52C. The trailing edge cover 52C covers a region from a position radially outward of the blade root R to the tip T in the radial direction. Further, the trailing edge cover 52C covers only a region biased toward the trailing edge E2 side among regions from the trailing edge E2 to the leading edge E1 side. Furthermore, in the present embodiment, the dimension of the trailing edge cover 52C in the radial direction is smaller than the dimension of the leading edge cover 52A in the radial direction.

The tip T is provided with a tip cover 52B. The tip cover 52B covers only a region biased toward the tip T side among regions from the tip T to the blade root R. In the present embodiment, the tip cover 52B is formed integrally with the leading edge cover 52A and the trailing edge cover 52C. Thus, the cover 52 is generally C-shaped in plan view.

In the present embodiment, the cover 52 is provided in each of all the compressor rotor blades 50 included in one compressor rotor blade row 23. Further, the weights of the cover 52 and 52′ are different between at least two compressor rotor blades 50 and 50′ among the plurality of compressor rotor blades 50 included in one compressor rotor blade row 23. In the present embodiment, the covers 52 and 52′ have different areas. To be specific, as illustrated in FIG. 4, in another compressor rotor blade 50′, the dimensions of the leading edge cover 52A′ and the trailing edge cover 52C′ in the chord direction (circumferential direction) are set to be smaller than those of the above-described leading edge cover 52A and trailing edge cover 52C. Thus, the weight of the cover 52′ is smaller than that of the cover 52.

On the other hand, the dimensions and weight of the blade body 51 are the same between these compressor rotor blades 50 and 50′. (Note that “the same” as used here means substantially the same, and manufacturing errors are allowed.) Therefore, the weight of the compressor rotor blade 50′ as a whole is smaller than the weight of the compressor rotor blade 50 as a whole by the difference in weight between the covers 52 and 52′. It is also possible to adopt a configuration in which the weights of the covers 52 and 52′ are changed by changing the material between the covers 52 and 52′. The weight of the covers 52 and 52′ is appropriately set within a range of 2 to 4% of the weight of the compressor rotor blades 50 and 50′ respectively. As a result, there is a difference of about 3% in the natural frequencies of the compressor rotor blades 50 and 50′.

### Operational Effects

Here, in a case where the plurality of compressor rotor blades 50 have the same weight (i.e., the same natural frequency), there is a concern that these blades resonate with each other and flutter develops in a self-excited manner. As a result, stable operation of the gas turbine (rotary machine) is inhibited.

However, according to the above configuration, the weight of the cover 52 differs between at least two compressor rotor blades 50 and 50′ among the plurality of compressor rotor blades 50. That is, since the two compressor rotor blades 50 and 50′ have different weights as a whole, their natural frequencies are different. Therefore, for example, even when flutter occurs in one of the compressor rotor blades 50, it is possible to reduce the possibility that the other compressor rotor blade 50′ resonates due to the flutter. This can avoid the development of flutter. As a result, the gas turbine 10 can be operated more stably.

According to the above configuration, the weight of the compressor rotor blade 50 can be easily changed only by changing the area of the cover 52 between the compressor rotor blades 50 and 50′. Therefore, a plurality of compressor rotor blades 50 having different natural frequencies can be easily obtained only by manufacturing the blade body 51 under a single shape, dimensions, and weight and attaching the cover 52 having different areas to the blade body 51.

According to the above configuration, the weight of the blades can be easily changed only by changing the material of the cover 52 between the compressor rotor blades 50 and 50′. Therefore, a plurality of compressor rotor blades 50 having different natural frequencies can be easily obtained only by manufacturing the blade bodies 51 under a single shape, dimensions, and weight and attaching the covers 52 made of different materials to the blade bodies 51.

According to the above configuration, the leading edge E1, the trailing edge E2, and the tip T of the blade body 51 can be uniformly covered by the leading edge cover 52A, the trailing edge cover 52C, and the tip cover 52B, respectively. Thus, the weight distribution of the compressor rotor blade 50 is smoothed. As a result, it is possible to avoid generation of unnecessary bending moment and torsional moment due to uneven distribution of weight, and generation of vibration due to bending and torsion.

According to the above configuration, the leading edge cover 52A is provided only in a region on the tip T side of the leading edge E1 Here, in the bending mode with the blade root R on the side opposite to the tip T as a fulcrum, the increase in weight on the tip T side is dominant over the change in natural frequency. In other words, by only slightly changing the weight on the tip T side, the natural frequency of the compressor rotor blade 50 as a whole can be changed more greatly. This makes it possible to effectively change the natural frequency while minimizing the weight increase due to the leading edge cover 52A.

According to the above configuration, the trailing edge cover 52C is provided only in a region on the tip T side of the trailing edge E2. Here, in the bending mode with the blade root R on the side opposite to the tip T as a fulcrum, the increase in weight on the tip T side is dominant over the change in natural frequency. In other words, by only slightly changing the weight on the tip T side, the natural frequency of the compressor rotor blade 50 as a whole can be changed more greatly. This makes it possible to effectively change the natural frequency while minimizing the weight increase due to the trailing edge cover 52C.

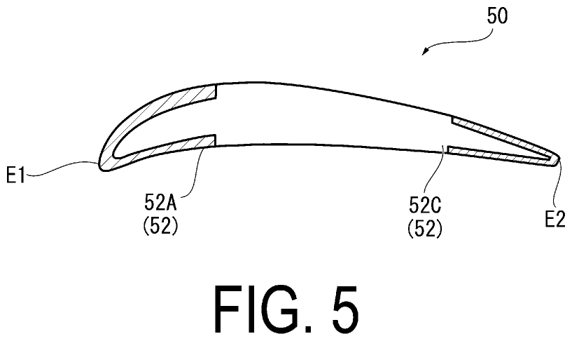

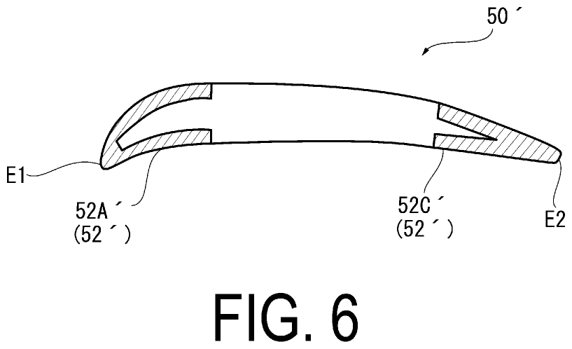

The second embodiment of the present disclosure has been described above. Various changes and modifications can be made to the above-described configuration without departing from the gist of the present disclosure. For example, as illustrated in FIGS. 5 and 6, it is also possible to adopt a configuration in which a difference in weight (i.e., a difference in natural frequency) is provided between the compressor rotor blades 50 and 50′ by changing the thickness of the cover 52 and 52′ between the plurality of compressor rotor blades 50. In this case, the compressor rotor blades 50 and 50′ have the same outer shape. When both the thickness and the area of the covers 52 and 52′ are different from each other, the compressor rotor blades 50 and 50′ having different weights can be easily distinguished from each other, so that it is possible to prevent the covers from being mistaken for each other. On the other hand, when only the thickness of the covers 52 and 52′ is different and the area is the same, it is possible to unify the aesthetics among the plurality of compressor rotor blades 50 and 50′, and thus it is possible to improve the aesthetics.

Furthermore, in the second embodiment described above, an example has been described in which the covers 52 are provided on all the compressor rotor blades 50 included in the compressor rotor blade row 23. However, the cover 52 may not necessarily be provided on each of the compressor rotor blade 50. For example, at least two compressor rotor blades 50 may be provided with covers 52. The weight of the cover 52 is different between the at least two compressor rotor blades 50 each including the cover 52. With such a configuration, the same effects as those described above can be obtained. Further, for example, it is possible to adopt a configuration in which a cover 52 made of a material having a density different from that of the blade body is provided on at least one compressor rotor blade 50, and the weights of the compressor blades are different, by the weight of the cover 52, between the compressor rotor blade 50 including the cover 52 and the compressor rotor blade 50 not including the cover. With such a configuration, the same effects as those described above can be obtained.

Further, in the second embodiment, the configuration in which the leading edge E1, the trailing edge E2, and the tip T of the blade body 51 are covered with the leading edge cover 52A, the trailing edge cover 52C, and the tip cover 52B, respectively, has been described. However, these covers 52 may be provided on at least one of the leading edge E1, the trailing edge E2, and the tip T. That is, it is possible to adopt a configuration including only the leading edge cover 52A, a configuration including only the trailing edge cover 52C, or a configuration including only the tip cover 52B. Further, at least two of the leading edge cover 52A, the trailing edge cover 52C, and the tip cover 52B may be combined.

### Third Embodiment

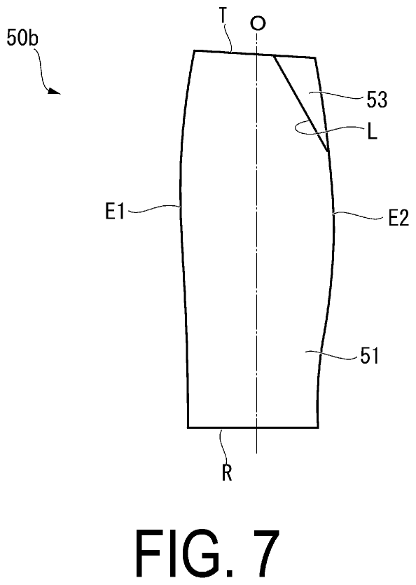

Next, a third embodiment of the present disclosure will be described with reference to FIG. 7. Note that the same components as those of the above-described embodiments will be denoted by the same reference signs, and a detailed description thereof will be omitted. As illustrated in the figure, in the compressor rotor blade 50b according to the present embodiment, the shape of a cover 53 is different from that of the first embodiment.

The cover 53 is provided only in a region on the tip T side of the trailing edge E2. Further, the cover 53 is provided only in a region biased toward the trailing edge E2 side from the center line O (line passing through the blade center of gravity) of the blade body 51. More specifically, the cover 53 preferably extends over a region within 20% from the trailing edge E2 side in the chord direction and a region within 20% from the tip T side in the blade length direction. Further, the end edge L of the cover 53 on the leading edge E1 side extends from the tip T side toward the blade root R side as the end edge L extends from the leading edge E1 side toward the trailing edge E2 side.

Similarly to the first embodiment, the weight of the cover 53 is configured to be different between at least two compressor rotor blades 50 among the plurality of compressor rotor blades 50. Further, in the present embodiment, the cover 53 is provided in each of all the compressor rotor blades 50 included in one compressor rotor blade row 23.

According to the above configuration, the cover 53 is provided only in a region on the tip T side of the trailing edge E2. Here, in the bending mode with the blade root R on the side opposite to the tip T as a fulcrum, the increase in weight on the tip T side is dominant over the change in natural frequency. In other words, by only slightly changing the weight on the tip T side, the natural frequency of the compressor rotor blade 50 as a whole can be changed more greatly. Further, during rotation of the compressor rotor blade 50, the shape of the leading edge E1 has a relatively large effect on aerodynamic performance, while the shape of the trailing edge E2 has a relatively small effect. Therefore, by providing the cover only on the trailing edge E2, the possibility that the aerodynamic performance of the compressor rotor blade 50 as a whole is affected can be reduced. In addition, when a torsional moment about the center line O of the blade body 51 (a line passing through the blade center of gravity) is considered, an increase in weight on the trailing edge E2 side is dominant over a change in natural frequencies. In other words, by only slightly changing the weight on the trailing edge E2 side, the natural frequency of the compressor rotor blade 50 as a whole can be changed to a greater extent.

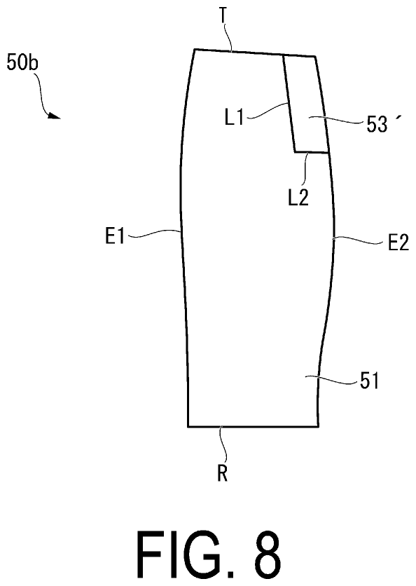

The third embodiment of the present disclosure has been described above. Various changes and modifications can be made to the above-described configuration without departing from the gist of the present disclosure. For example, as illustrated in FIG. 8, the cover 53′ may be formed in a rectangular shape in plan view. To be specific, in this configuration, the end edge L1 on the leading edge E1 side of the cover 53′ extends along the planar shape of the trailing edge E2. The end edge L2 on the blade root R side extends along the planar shape of the tip T. According to such a configuration, for example, by making the dimensions of the end edge L1 and the end edge L2 different between the plurality of compressor rotor blades 50, it is possible to make the natural frequencies different more easily.

Furthermore, in the third embodiment described above, an example has been described in which the covers 53 are provided on all of the compressor rotor blades 50 included in the compressor rotor blade row 23. However, the cover 53 may not necessarily be provided on all of the compressor rotor blades 50. For example, at least two compressor rotor blades 50 may be provided with the covers 53 respectively. The weight of the cover 53 is different between the at least two compressor rotor blades 50 each including the cover 53. With such a configuration, the same effects as those described above can be obtained. Further, for example, it is possible to adopt a configuration in which a cover 53 made of a material having a density different from that of the blade body is provided on at least one compressor rotor blade 50, and the weight is different, by the weight of the cover 53, between the compressor rotor blade 50 including the cover 53 and the compressor rotor blade 50 not including the cover. With such a configuration, the same effects as those described above can be obtained.

### Notes

The rotary machine (gas turbine 10) described in each embodiment is understood as follows, for example.

(1) A rotary machine (gas turbine 10) according to a first aspect includes a rotor shaft 22 rotatable about an axis Ar, a plurality of blades (compressor rotor blades 50) extending radially outward from the rotor shaft 22 and arranged in a circumferential direction, and a casing (compressor casing 25) that covers the rotor shaft 22 and the plurality of blades from an outer peripheral side. Each of the plurality of blades includes a blade body 51 including a leading edge E1 facing forward in a rotational direction of the rotor shaft 22, a trailing edge E2 facing backward, and a tip T facing radially outward, and a weight of the blade body 51 is different between at least two of the plurality of blades.

According to the above configuration, the weight of the blade body 51 differs between at least two blades among the plurality of blades. That is, since there is a difference in weight as a whole between these two blades, the natural frequencies are different. Therefore, for example, even when flutter occurs in one blade, it is possible to reduce the possibility that the flutter causes the other blade to resonate. This makes it possible to avoid self-excited development of flutter.

(2) A rotary machine (gas turbine 10) according to a second aspect includes a rotor shaft 22 rotatable about an axis Ar, a plurality of blades (compressor rotor blades 50) extending radially outward from the rotor shaft 22 and arranged in a circumferential direction, and a casing (compressor casing 25) that covers the rotor shaft 22 and the plurality of blades from an outer peripheral side. Each of the plurality of blades includes a blade body 51 including a leading edge E1 facing forward in a rotational direction of the rotor shaft 22, a trailing edge E2 facing backward, and a tip T facing radially outward. At least one of the plurality of blades is provided with a cover 52 on at least one of the leading edge E1, the trailing edge E2, and the tip T, and a weight of the blade including the cover 52 and a weight of the blade not including the cover are different.

According to the above configuration, among the plurality of blades, the weight of the blade is different between the blade, which includes the cover 52 made of a material having a density different from that of the blade body, and the blade that does not include the cover. That is, since there is a difference in weight as a whole between these two blades, the natural frequencies are different. Therefore, for example, even when flutter occurs in one blade, it is possible to reduce the possibility that the flutter causes the other blade to resonate. This makes it possible to avoid self-excited development of flutter.

(3) A rotary machine (gas turbine 10) according to a third aspect includes a rotor shaft 22 rotatable about an axis Ar, a plurality of blades (compressor rotor blades 50) extending radially outward from the rotor shaft 22 and arranged in a circumferential direction, and a casing (compressor casing 25) that covers the rotor shaft 22 and the plurality of blades from an outer peripheral side. Each of the plurality of blades includes a blade body 51 including a leading edge E1 facing forward in a rotational direction of the rotor shaft 22, a trailing edge E2 facing backward, and a tip T facing radially outward. At least two of the plurality of blades are each provided with a cover 52 on at least one of the leading edge E1, the trailing edge E2, and the tip T, and a weight of the cover 52 is different between the at least two of the blades among the plurality of blades including the cover 52.

According to the above configuration, the weight of the cover 52 is different between at least two blades each including the cover 52 among the plurality of blades. That is, since there is a difference in weight as a whole between these two blades, the natural frequencies are different. Therefore, for example, even when flutter occurs in one blade, it is possible to reduce the possibility that the flutter causes the other blade to resonate. This makes it possible to avoid self-excited development of flutter.

(4) In a rotary machine (gas turbine 10) according to a fourth aspect, an area of the cover 52 is different between the at least two of the plurality of blades.

According to the above configuration, the weight of the blade can be easily changed only by changing the area of the cover 52 between the blades. Therefore, a plurality of blades having different natural frequencies can be easily obtained only by manufacturing the blade body 51 under a single shape, dimensions, and weight and attaching the cover 52 having different area to the blade body 51.

(5) In a rotary machine (gas turbine 10) according to a fifth aspect, a material of the cover 52 is different between the at least two of the plurality of blades.

According to the above configuration, the weight of the blade can be easily changed only by changing the material of the cover 52 between the blades. Therefore, a plurality of compressor rotor blades having different natural frequencies can be easily obtained only by manufacturing the blade body 51 under a single shape, dimensions, and weight and attaching the cover 52 including different materials to the blade body 51.

(6) In a rotary machine (gas turbine 10) according to a sixth aspect, a thickness of the cover 52 is different between the at least two of the plurality of blades.

According to the above configuration, the weight of the blade can be easily changed only by changing the thickness of the cover 52 between the blades. Therefore, a plurality of blades having different natural frequencies can be easily obtained only by manufacturing the blade body 51 under a single weight and attaching the covers 52 having different thicknesses to the blade body 51.

(7) In a rotary machine (gas turbine 10) according to a seventh aspect, the cover 52 includes a leading edge cover 52A provided on the leading edge E1, a trailing edge cover 52C provided on the trailing edge E2, and a tip cover 52B provided on the tip T.

According to the above configuration, the leading edge E1, the trailing edge F2, and the tip T of the blade body can be uniformly covered by the leading edge cover 52A, the trailing edge cover 52C, and the tip cover 52B, respectively. Thus, the weight distribution of the blade is smoothed. As a result, it is possible to avoid generation of unnecessary bending moment and torsional moment due to uneven distribution of weight, and generation of vibration due to bending and torsion.

(8) In a rotary machine (gas turbine 10) according to an eighth aspect, the leading edge cover 52A is provided only in a region on the tip T side of the leading edge E1.

According to the above configuration, the leading edge cover 52A is provided only in the region on the tip T side of the leading edge E1. Here, in the bending mode with the blade root R on the side opposite to the tip T as a fulcrum, the increase in weight on the tip T side is dominant over the change in natural frequency. In other words, by only slightly changing the weight on the tip T side, the natural frequency of the blade as a whole can be changed more greatly. This makes it possible to effectively change the natural frequency while minimizing the weight increase due to the leading edge cover 52A.

(9) In a rotary machine (gas turbine 10) according to a ninth aspect, the trailing edge cover 52C is provided only in a region on the tip T side of the trailing edge E2.

According to the above configuration, the trailing edge cover 52C is provided only in the region on the tip T side of the trailing edge E2. Here, in the bending mode with the blade root R on the side opposite to the tip T as a fulcrum, the increase in weight on the tip T side is dominant over the change in natural frequency. In other words, by only slightly changing the weight on the tip T side, the natural frequency of the blade as a whole can be changed more greatly. This makes it possible to effectively change the natural frequency while minimizing the weight increase due to the trailing edge cover 52C.

(10) In a rotary machine (gas turbine 10) according to a tenth aspect, the cover 53 is provided only in a region on the tip T side of the trailing edge E2.

According to the above configuration, the cover 53 is provided only in the region on the tip T side of the trailing edge E2. Here, in the bending mode with the blade root R on the side opposite to the tip T as a fulcrum, the increase in weight on the tip T side is dominant over the change in natural frequency. In other words, by only slightly changing the weight on the tip T side, the natural frequency of the blade as a whole can be changed more greatly. Further, during rotation of the blade, the shape of the leading edge E1 has a relatively large effect on aerodynamic performance, while the shape of the trailing edge E2 has a relatively small effect. Therefore, by providing the cover only on the trailing edge E2, the possibility that the aerodynamic performance of the blade as a whole is affected can be reduced. In addition, when a torsional moment about the center line O (a line passing through the blade center of gravity) of the blade body 51 is considered, an increase in weight on the trailing edge E2 side is dominant over a change in natural frequencies. In other words, by only slightly changing the weight on the trailing edge E2 side, the natural frequency of the blade as a whole can be changed to a greater extent.

While preferred embodiments of the invention have been described as above, it is to be understood that variations and modifications will be apparent to those skilled in the art without departing from the scope and spirit of the invention. The scope of the invention, therefore, is to be determined solely by the following claims.

1. A rotary machine, comprising:
a rotor shaft that is rotatable about an axis;
a plurality of blades extending radially outward from the rotor shaft and arranged in a circumferential direction; and
a casing that covers the rotor shaft and the plurality of blades from an outer peripheral side, wherein
each of the plurality of blades includes a blade body including a leading edge facing forward in a rotational direction of the rotor shaft, a trailing edge facing backward, and a tip facing radially outward,
a weight of the blade body is different between the at least two of the plurality of blades.

2. A rotary machine, comprising:
a rotor shaft that is rotatable about an axis;
a plurality of blades extending radially outward from the rotor shaft and arranged in a circumferential direction; and
a casing that covers the rotor shaft and the plurality of blades from an outer peripheral side, wherein
each of the plurality of blades includes a blade body including a leading edge facing forward in a rotational direction of the rotor shaft, a trailing edge facing backward, and a tip facing radially outward,
at least one of the plurality of blades is provided with a cover on at least one of the leading edge, the trailing edge, and the tip, and
a weight of the blade including the cover and a weight of the blade not including the cover are different.

3. A rotary machine, comprising:
a rotor shaft that is rotatable about an axis;
a plurality of blades extending radially outward from the rotor shaft and arranged in a circumferential direction; and
a casing that covers the rotor shaft and the plurality of blades from an outer peripheral side, wherein
each of the plurality of blades includes a blade body including a leading edge facing forward in a rotational direction of the rotor shaft, a trailing edge facing backward, and a tip facing radially outward,
at least two of the plurality of blades are each provided with a cover on at least one of the leading edge, the trailing edge, and the tip, and
a weight of the cover is different between the at least two of the blades among the plurality of blades including the cover.

4. The rotary machine according to claim 3, wherein an area of the cover is different between the at least two of the plurality of blades.

5. The rotary machine according to claim 3, wherein a material of the cover is different between the at least two of the plurality of blades.

6. The rotary machine according to claim 3, wherein a thickness of the cover is different between the at least two of the plurality of blades.

7. The rotary machine according to claim 2, wherein the cover includes a leading edge cover provided on the leading edge, a trailing edge cover provided on the trailing edge, and a tip cover provided on the tip.

8. The rotary machine according to claim 7, wherein the leading edge cover is provided only in a region on the tip side of the leading edge.

9. The rotary machine according to claim 7, wherein the trailing edge cover is provided only in a region on the tip side of the trailing edge.

10. The rotary machine according to claim 3, wherein the cover includes a leading edge cover provided on the leading edge, a trailing edge cover provided on the trailing edge, and a tip cover provided on the tip.

11. The rotary machine according to claim 10, wherein the leading edge cover is provided only in a region on the tip side of the leading edge.

12. The rotary machine according to claim 10, wherein the trailing edge cover is provided only in a region on the tip side of the trailing edge.

13. The rotary machine according to claim 2, wherein the cover is provided only in a region on the tip side of the trailing edge.

14. The rotary machine according to claim 3, wherein the cover is provided only in a region on the tip side of the trailing edge.
